(19) United States
(12) Patent Application Publication
(10) Pub. No.: US 2019/0185035 A1
(43) Pub. Date: Jun. 20, 2019

(54) PROCEDURE FOR TRACKING RADIO EQUIPPED VEHICLES WITHOUT ODOMETER

(71) Applicant: ALSTROM Transport Technologies, Saint-Ouen (FR)

(72) Inventor: Javier BALLESTEROS, Paris (FR)

(21) Appl. No.: 16/223,459

(22) Filed: Dec. 18, 2018

(30) Foreign Application Priority Data
Dec. 20, 2017 (FR) 17 62614

(51) Int. Cl. B61L 25/02; G01S 19/50; B61L 25/04

(52) U.S. Cl. CPC B61L 25/025; B61L 2205/04; B61L 25/04; G01S 19/50

(57) ABSTRACT

A method for locating a railway vehicle in a railway network, including first detection devices detecting the passage of a railway vehicle in a first perimeter, second detection devices detecting the passage of a railway vehicle in a second perimeter and a centralized server, includes the following steps: detection, by one of the first detection devices, of the passage of the railway vehicle and sending of a first detection signal; detection, by one of the second detection devices, of the passage of the railway vehicle and sending of a second detection signal; and reception of the signals by the centralized server and determination of the position of the railway vehicle on the railway network by intersection of the first perimeter and the second perimeter.

### CROSS-REFERENCE TO RELATED APPLICATIONS

This application is a U.S. non-provisional application claiming the benefit of French Application No. 17 62614, filed on Dec. 20, 2017, which is incorporated herein by reference in its entirety.

### FIELD OF THE INVENTION

The present invention relates to a method for locating at least one railway vehicle in a railway network, the railway network comprising a plurality of first detection devices, each first detection device being configured to detect the passage of a railway vehicle in a first given perimeter associated with said first detection device, a plurality of second detection devices different from the first detection devices, each second detection device being configured to detect the passage of a railway vehicle in a second given perimeter associated with said second detection device and a centralized server, the method comprising, for each railway vehicle, the following steps:

detection by at least one of the first detection devices of the passage of said railway vehicle in the first perimeter;

transmission of a first detection signal by each first detection device having detected the presence of the railway vehicle in the first associated perimeter;

detection by at least one of the second detection devices of the passage of said railway vehicle in the second perimeter;

transmission of a second detection signal by each second detection device having detected the presence of the railway vehicle in the second associated perimeter;

reception of the at least one first detection signal and the at least one second detection signal by the centralized server; and

determination of the position of the railway vehicle on the railway network by the centralized server.

In the present document, a railway vehicle refers to any guided vehicle able to move over a track of a railway network, for example a train, tram, subway.

### BACKGROUND

The precise location of the railway vehicles in the railway network is essential in order to see to the completely safe circulation of all of the railway vehicles traveling over the tracks of the railway network without risk of accident between two railway vehicles present on a same track.

Additionally, there is a need for maintenance operators to know the position of the various maintenance vehicles present on the railway network in order to resolve any problem affecting the railway network quickly.

To that end, it is known to have, in the railway network, a plurality of beacons and to equip the railway vehicles intended to transport travelers and/or goods with a beacon detector and an odometer making it possible to measure the distance traveled by the vehicle. Thus, the position of the railway vehicle is recalibrated upon each passage by a beacon of the railway network, the odometer making it possible to locate the railway vehicle precisely between two beacons.

However, such an odometer is expensive, and it is preferable to avoid equipping all maintenance vehicles with them, all of the latter not having the same requirements in terms of geolocation precision and communication security as the vehicles for transporting travelers and/or goods.

Document WO 2007/078704 describes a railway vehicle tracking method in a railway network using a detection device arranged in the railway network, such as a GPS device, for example, and a database comprising a map of the railway network. The railway vehicle is located in the railway network by comparison between the geographical data from the detection device and the database.

However, such a method is not fully satisfactory. Indeed, the method does not only use the geographical data from the detection device. As a result, in case of failure or poor precision of the detection device, for example for GPS in a tunnel, the railway vehicles are no longer located precisely in the railway network.

One aim of the invention is therefore to obtain a method for locating railway vehicles in a railway network that is inexpensive while allowing precise location at any moment of the railway vehicles.

### SUMMARY

To that end, the invention relates to a method of the aforementioned type, wherein the determination of the position of each railway vehicle is made from the first detection signal and the second detection signal, by intersection of the first perimeter associated with said first detection signal and the second perimeter associated with said second detection signal.

The determination of the location of the railway vehicle is therefore made using at least two different location devices thus allowing greater precision and redundancy of the detection devices in case of failure of one of the detection devices. Thus, the determination of the location is precise and possible at any moment.

The method according to the invention may comprise one or more of the following features, considered alone or according to any technically possible combination:

the railway network further comprises a plurality of third detection devices, each third detection device being configured to detect the passage of a railway vehicle in a given third perimeter associated with said third detection device, the method also comprising the following steps:
detection by at least one of the third detection devices of the passage of said railway vehicle in the third perimeter;
transmission of a third detection signal by each third detection device having detected the presence of the railway vehicle in the third associated perimeter;
   the determination of the position of each railway vehicle further being made from the third detection signal, by intersection of the first perimeter associated with said first detection signal, the second perimeter associated with said second detection signal and the third perimeter associated with said third detection signal;

the method further comprises a step for transmission by the centralized server of the position of each railway vehicle on the railway network to each railway vehicle;

the method further comprises a step for transmission by the centralized server of the position of the at least one railway vehicle on the railway network to an operator;

each detection device sends the detection signal to the detected railway vehicle, then said railway vehicle sends a request signal comprising the detection signals to the centralized server;

each railway vehicle further sends a unique identification code to the centralized server;

the railway vehicle has no on-board geolocation means;

the railway vehicle is a maintenance vehicle capable of performing maintenance on the railway network;

the geolocation devices are part of the list of the following devices:
an axle counter;
a switch;
a beacon;
a GPS location system;
a radio antenna;
a laser detector;
a track circuit.

the centralized server records the history of the positions of each railway vehicle on the tracks of the railway network.

### BRIEF DESCRIPTION OF THE DRAWINGS

The invention will be better understood upon reading the following description, provided solely as an example and done in reference to the appended drawings, in which:

FIG. 1 is a schematic side view of two railway vehicles located in a railway network using a method according to the invention; and

FIG. 2 is a schematic side view of a railway vehicle located in a railway network using an alternative of the method according to the invention.

### DETAILED DESCRIPTION

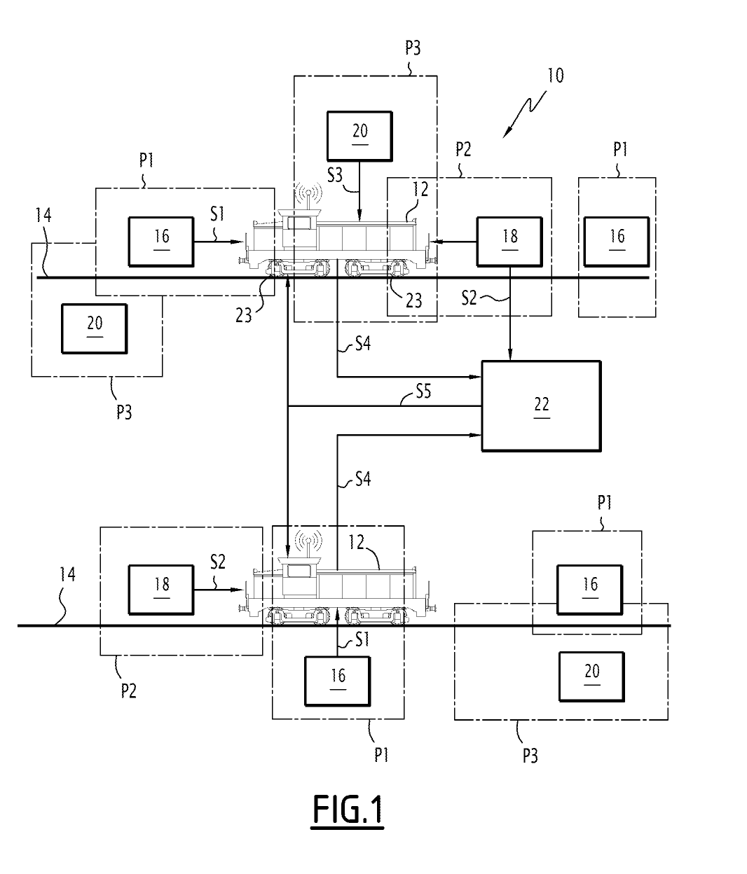

The railway network 10, shown in FIG. 1, comprises a plurality of railway vehicles 12, a plurality of tracks 14, at least one plurality of first detection devices 16, at least one plurality of second detection devices 18, advantageously, according to one embodiment, a plurality of third detection devices 20 and a centralized server 22.

Each railway vehicle 12 is for example a train car transporting travelers and/or goods or a maintenance vehicle able to perform maintenance on the railway network 10 and/or to solve problems affecting the railway network 10. For example, a maintenance vehicle is able to perform maintenance on the tracks 14 of the railway network 10.

Each railway vehicle 12 is provided with wheels 23. The wheels 23 are attached to the rest of the railway vehicle 12 by axles, not shown in the figures.

The wheels 14 are equipped with rails, the wheels 23 of the railway vehicles 12 being arranged on the rails.

Each railway vehicle 12 is able to circulate on the tracks 14 in order to move in the railway network 10.

Each first detection device 16 is configured to detect the passage of the railway vehicle 12 in a given first perimeter P1 associated with the first detection device 16.

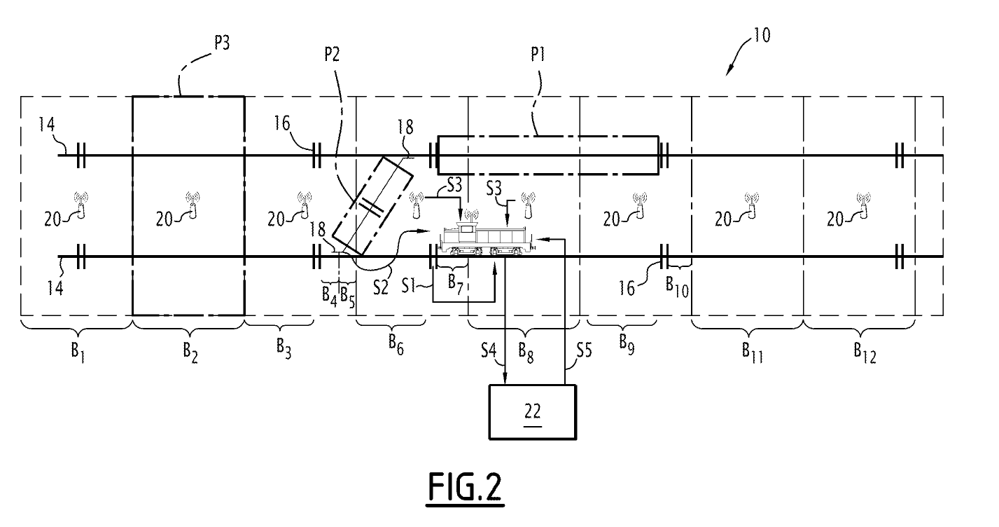

In the example shown in FIG. 2, the first detection devices 16 are axle counters located on the tracks 14. Each axle counter is able to count the axles of a railway vehicle 12 passing over the track 14 associated with the axle counter. By comparing the number of axles counted by two axle counters located at two ends of a segment of a track 14, the presence or absence of the railway vehicle 12 on the segment is deduced. The associated first perimeter P1 is then the length of the segment.

The first detection devices 16 are for example distributed along the tracks 14 such that all of the tracks 14 of the railway network 10 are cut into segments. The first perimeter P1 associated with a first detection device 16 is formed by the segment(s) on which the first detection device 16 is able to detect the presence of a railway vehicle 12.

Each second detection device 18 is configured to detect the passage of the railway vehicle 12 in a given second perimeter P2 associated with said second detection device 18.

The second detection device 18 is different from the first detection device 16. Different means that the first detection device 16 and the second detection device 18 do not work using a same technology and detect the railway vehicle 12 differently.

In the example shown in FIG. 2, the second detection devices 18 are switches capable of causing the railway vehicles 12 to change tracks 14.

Each switch is configured to provide information making it possible to determine the branch on which a railway vehicle 12 passing on said switch is steering itself. The track 14 downstream from the switch on which the railway vehicle 12 is located is then known. The associated second perimeter P2 is then the segment between two consecutive switches.

The second detection devices 18 are for example distributed along the tracks 14 such that all of the tracks 14 of the railway network 10 are cut into segments. The second perimeter P2 associated with a second detection device 18 is formed by the segment(s) on which the second detection device 18 is configured to determine the presence of a railway vehicle 12.

According to one embodiment, each third detection device 20 is configured to detect the passage of the railway vehicle 12 in a given third perimeter P3 associated with said third detection device 20.

The third detection device 20 is different from the first detection device 16 and the second detection device 18.

In the example shown in FIG. 2, the third detection devices 20 are radio antennas arranged regularly along the tracks 14. Each radio antenna is capable of detecting the passage of a railway vehicle 12 near said radio antenna. The third perimeter P3 is then the detection zone surrounding the radio antenna.

The third detection devices 20 are for example distributed along the tracks 14 such that all of the tracks 14 of the railway network 10 are cut into segments. The third perimeter P3 associated with a third detection device 20 is formed by the segment(s) on which the third detection device 20 is able to detect the presence of the railway vehicle 12.

In the example described below, the railway network 10 comprises three different detection devices 16, 18, 20. However, the invention applies once the railway network 10 comprises only two different detection devices. Advantageously, the railway network 10 of the method according to the invention comprises more than three different detection devices. Indeed, as shown by the explanation below, the more different detection devices the railway network 10 comprises, the more effective the localization of a railway vehicle 12 is.

The first detection devices 16, the second detection devices 18 and the third detection devices 20 are advantageously chosen from among: an axle counter, a switch, a beacon, GPS location, a track circuit, a radio antenna or a laser detector installed on the tracks, the detection devices 16, 18, 20 being different from one another.

Advantageously, the railway network 10 according to the invention allows the detection of one or several railway vehicles 12 without on-board geolocation means, in particular an odometer, and thus allowing localization of railway vehicles 12, in which on-board geolocation equipment has not been installed. This is for example the case for maintenance vehicles present in the railway network 10.

A first method for locating a railway vehicle 12 in the railway network 10 according to the invention will now be described.

Initially, as shown in FIG. 2, the railway vehicle 12 is located on a track 14 of the railway network 10.

At least a first detection device 16 is configured to detect the passage of the railway vehicle 12 in the perimeter P1 associated with said first detection device 16.

The first detection device 16 sends a first detection signal S1, the detection signal S1 being sent to the centralized server 22 or the railway vehicle 12. The first detection signal S1 is representative of the location of a railway vehicle 12 in the first perimeter P1 associated with first detection device 16. Thus, in the case of an axle counter, the first signal S1 is representative of the presence of the railway vehicle 12 on one of the segments associated with the axle counter.

At least a second detection device 18 is configured to detect the passage of the railway vehicle 12 in the perimeter P2 associated with said second detection device 18.

The second detection device 18 sends a second detection signal S2, the detection signal S2 being sent to the centralized server 22 or the railway vehicle 12. The second detection signal S2 is representative of the location of a railway vehicle 12 in the second perimeter P2 associated with second detection device 18. Thus, in the case of a switch, the second signal S2 is representative of the presence of the railway vehicle 12 on one of the tracks 14 associated with the switch.

Advantageously, at least a third detection device 20 detects the passage of the railway vehicle 12 in the perimeter P3 associated with said third detection device 20. The third detection device 20 sends a third detection signal S3, the detection signal S3 being sent to the centralized server 22 or the railway vehicle 12. The third detection signal S3 is representative of the location of a railway vehicle 12 in the third perimeter P3 associated with third detection device 20. Thus, in the case of a radio antenna, the third signal S3 is representative of the presence of the railway vehicle 12 in the detection zone associated with the radio antenna.

Thus, the at least one first detection signal S1, the at least one second detection signal S2 and the at least one detection signal S3 are received by the railway vehicle 12 or directly by the centralized server 22.

The railway vehicle 12 advantageously receives the at least one first detection signal S1, the at least one second detection signal S2 and the at least one detection signal S3. The railway vehicle 12 next sends a request signal S4 comprising the at least one first detection signal S1, the at least one second detection signal S2 and the at least one third detection signal S3 to the centralized server 22.

The passage of the three detection signals S1, S2 and S3 by the railway vehicle 12 thus makes it possible for the three detection signals S1, S2 and S3 to be sent using a unique request signal S4 associated with the railway vehicle 12 allowing a simplified management at the centralized server 22.

The request signal S4 advantageously comprises an identification code associated uniquely with said railway vehicle 12 in order for the centralized server 22 to identify the railway vehicle 12 and distinguish it from the other railway vehicles 12 circulating on the tracks 14 of the railway network 10.

The centralized server 22 receives the request signal S4. The centralized server 22 next determines the position of the railway vehicle 12 from the request signal S4. The determination of the position of the railway vehicle 12 is done systematically by intersection, or crossing, between a first perimeter P1, a second perimeter P2 and advantageously a third perimeter P3.

The obtained position of the railway vehicle 12 is then much more precise than the position of the railway vehicle 12 estimated by each of the detection devices 16, 18, 20 considered separately.

In the example illustrated in FIG. 2, the switch detects that the railway vehicle 12 is on the track segment 14 comprising sections B5 to B12. The axle counter detects that the railway vehicle 12 is located on the track segment 14 comprising sections B7 to B9. A first radio antenna detects that the railway vehicle 12 is located in the zone comprising sections B5 to B7 and a second radio antenna detects that the railway vehicle 12 is located in the zone comprising section B8. By intersection, the centralized server 22 deduces from this that the railway vehicle 12 is located in sections B7 and B8.

In case of failure or insufficient precision of one of the detection devices 16, 18, 20, the perimeter P1, P2, P3 associated with the defective detection device 16, 18, 20 is presumed to be the entire railway network 10 so as not to disrupt the determination of the position of the railway vehicle 12.

The centralized server 22 advantageously records the history of the positions of the railway vehicle 12 in the railway network 10.

The history of the positions of the railway vehicle 12 is taken into account in determining the position of the railway vehicle 12 in the railway network 10. Following the intersection of the perimeters P1, P2, P3 of the detection devices 16, 18, 20, the centralized server 22 compares the position of the railway vehicle 12 determined by the intersection of the perimeters P1, P2, P3 to the previous position of the railway vehicle 12 recorded by the centralized server 22. The centralized server 22 verifies the consistency between the two positions.

If the two positions are considered to be consistent, the centralized server 22 records the position determined by the intersection of the perimeters P1, P2 and P3 and the centralized server 22 considers that the position determined by the intersection of the perimeters P1, P2 and P3 is the current position of the railway vehicle 12.

Coherence between the two positions means that the two positions are separated by a distance smaller than the theoretical distance traveled by the railway vehicle 12 at a maximum speed estimated during the same time interval and that the railway vehicle 12 is still on the same track 14.

If an incoherence is detected, for example an instantaneous change of tracks 14, the centralized server 22 does not record the position determined by the intersection of the perimeters P1, P2, P3 and considers that the preceding position of the railway vehicle 12 is still the current position of the railway vehicle 12.

The centralized server 22 next advantageously sends a position signal S5 comprising the position of the railway vehicle 12 in the railway network 10 estimated by the centralized server 22 to the railway vehicle 12. The railway vehicle 12 thus knows its position in the railway network 10.

The centralized server 22 also advantageously sends the position of the railway vehicle 12 to an operator. The operator is for example a maintenance operator and the railway vehicle 12 is for example a maintenance vehicle. The maintenance operator thus knows the position of the maintenance vehicle and can quickly access said maintenance vehicle to resolve a potential problem having occurred on the railway network 10.

Alternatively, a second method for locating a plurality of railway vehicles 12 in the railway network 10 according to the invention will now be described.

Each railway vehicle 12 is located in the railway network 10 in a manner similar to the first localization method.

The second localization method differs from the first localization method in that the position signal S5 sent by the central server 22 comprises the position of all of the railway vehicles 12 in the railway network 10.

As illustrated in FIG. 1, each railway vehicle 12 advantageously receives the position signal S5. Thus, each railway vehicle 12 knows the position of the other railway vehicles 12 in the railway network 10, thus allowing stronger circulation safety of the railway vehicles 12 in the railway network 10.

The operator also advantageously receives the position signal S5. The operator therefore knows the position of all of the railway vehicles 12 in the railway network 10. In case of any problems in the railway network 10, the maintenance operator can thus choose the maintenance vehicle closest to the incident.

Owing to the features described above, the localization of the railway vehicles 12 in the railway network 10 is therefore done inexpensively, precisely and redundantly. Indeed, the localization of the railway vehicle 12 is done using detection devices 16, 18, 20 already located on the railway network 10 and therefore does not require additions of extra equipment in the railway network 10. The railway vehicle 12 advantageously not having on-board geolocation means, the method according to the invention also does not require the installation of a specific device in the railway vehicle 12. Furthermore, the location of each railway vehicle 12 being done systematically using at least two detection devices 16, 18, 20, the positioning of the railway vehicle 12 is more precise than the positioning estimated by each detection device 16, 18, 20 taken separately. All of the railway devices 12 and the maintenance operators thus have a precise view of the position of each railway vehicle 12 in the railway network 10. In case of failure of one of the detection devices 16, 18, 20, the positioning of the railway vehicle 12 is still possible, thus allowing stronger railway security.

1. A method for locating at least one railway vehicle in a railway network, the railway network comprising:
a plurality of first detection devices, each first detection device being configured to detect the passage of a railway vehicle in a given first perimeter associated with said first detection device;
a plurality of second detection devices different from the first detection devices, each second detection device being configured to detect the passage of a railway vehicle in a given second perimeter associated with said second detection device; and
a centralized server;
the method comprising, for each railway vehicle, the following steps:
detection, by at least one of the first detection devices, of the passage of said railway vehicle in the first perimeter;
transmission of a first detection signal by each first detection device having detected the presence of the railway vehicle in the first associated perimeter;
detection, by at least one of the second detection devices, of the passage of said railway vehicle in the associated second perimeter;
transmission of a second detection signal by each second detection device having detected the presence of the railway vehicle in the second associated perimeter;
reception of the at least one first detection signal and the at least one second detection signal by the centralized server; and
determination of the position of the railway vehicle on the railway network by the centralized server;
wherein the determination of the position of each railway vehicle is made from the first detection signal and the second detection signal, by intersection of the first perimeter associated with said first detection signal and the second perimeter associated with said second detection signal.

2. The method according to claim 1, wherein the railway network further comprises a plurality of third detection devices different from the first detection devices and the second detections devices, each third detection device being configured to detect the passage of a railway vehicle in a given third perimeter associated with said third detection device, the method also comprising the following steps:
detection, by at least one of the third detection devices, of the passage of said railway vehicle in the third perimeter;
transmission of a third detection signal by each third detection device having detected the presence of the railway vehicle in the third associated perimeter;
reception of the at least one third detection signal by the centralized server;
the determination of the position of each railway vehicle further being made from the third detection signal, by intersection of the first perimeter associated with said first detection signal, the second perimeter associated with said second detection signal and the third perimeter associated with said third detection signal.

3. The method according to claim 1, further comprising a step for transmission by the centralized server of the position of each railway vehicle on the railway network to each railway vehicle.

4. The method according to claim 1, further comprising a step for transmission by the centralized server of the position of the at least one railway vehicle on the railway network to an operator.

5. The method according to claim 1, wherein each detection device sends the detection signal to the detected railway vehicle, then said railway vehicle sends a request signal comprising the detection signals to the centralized server.

6. The method according to claim 5, wherein each railway vehicle further sends a unique identification code to the centralized server.

7. The method according to claim 1, wherein the railway vehicle has no on-board geolocation means.

8. The method according to claim 7, wherein the railway vehicle has no odometer.

9. The method according to claim 1, wherein the railway vehicle is a maintenance vehicle capable of performing maintenance on the railway network.

10. The method according to claim 1, wherein the first, second and third detection devices are part of the list of the following devices:
an axle counter;
a switch;
a beacon;
a GPS location system;
a radio antenna;
a laser detector;
a track circuit.

11. The method according to claim 1, wherein the centralized server records the history of the positions of each railway vehicle on the tracks of the railway network.
